(19) United States
(12) Patent Application Publication
(10) Pub. No.: US 2007/0137749 A1
(43) Pub. Date: Jun. 21, 2007

(54) Tire with tread pattern

(75) Inventor: Daniel S. Mathews, Mount Vernon, IL (US)

Correspondence Address: GREENBLUM & BERNSTEIN, P.L.C., 1950 ROLAND CLARKE PLACE, RESTON, VA, 20191, US

(73) Assignee: Continental AG, Hannover (DE)

(21) Appl. No.: 11/311,330

(22) Filed: Dec. 20, 2005

(51) Int. Cl. B60C 11/11

(52) U.S. Cl. 152/209.15; 152/209.18; 152/902

(57) ABSTRACT

A tire has a tread pattern with superior performance characteristics. The tread pattern includes a generally oval shaped lug pattern having sidewalls that are of a variable angle. The sidewalls are also formed at an angle with respect to a vertical axis. The transitions between the sidewalls, as well as between the sidewalls and the oval shaped lug pattern have rounded edges to reduce stress components. A base of the lug is generally rectangular with convex sides.

### FIELD OF THE INVENTION

The invention generally relates to a pneumatic tire having a tread pattern and, more particularly, to a pneumatic tire for a vehicle having a tread pattern that provides superior performance characteristics.

### BACKGROUND OF INVENTION

Tire design and more specifically tread pattern design plays a critical role in the safe and efficient operation of a vehicle. For example, it is known that the tread pattern assists in the generation of steering forces, as well as driving and braking forces. Also, the tread pattern can improve vehicle performance by reducing road noise, providing superior grip capabilities in both wet and/or dry driving conditions, as well as minimizing rolling resistance to increase the overall fuel economy of the vehicle.

In examining the complex mechanisms involved in proper tread pattern design, several factors play a role in the final design of the tread pattern. These factors include industry standards, government regulations, customer specifications, marketing requirements and the like. On the other hand, the complex mechanisms which are taken into account in the design of the tread pattern include, amongst other mechanisms, stresses generated upon the tire during driving conditions, energy losses due to rolling resistance, sidewall flexing, to a host of other mechanisms. Thus, the design of a tread pattern is not a trivial task and, in fact, is quite complex requiring the need to take into account many different considerations.

In practice, the design of a tire tread pattern also requires the balancing of many contradictory demands. Finding the proper structure that balances these demands for any given tire is thus a great challenge. For this and other reasons, engineers typically focus on a large array of considerations, placing emphasis on certain design criteria over others, depending on the specific application of the tire. However, by focusing on these design criteria, other criteria such as tire wear or stress components may not have been weighed as heavily during the design stage.

By way of a more specific illustration, one design approach has been to form grooves between ribs with negatively sloped walls to increase gripping capabilities. However, in such an approach, the grooves are more likely to trap and retain stones, which can damage the tire. Another example is in the use of all-season tires, which customarily employ block elements in their tread design. These designs have superior grip performance but tend to have increased noise level, as well as have a tendency toward irregular wear due primarily to their lack of stiffness in the circumferential direction of the tread. Such noise generation and irregular wear are accentuated at acute or sharp angles in the rubber blocks formed by intersections of groove walls.

In any event, tire patterns have common pattern traits. These common pattern traits include, for example, grooves with sharp or acute angles in transitional areas, e.g., between treads, vertical walls forming the grooves or treads, etc. It has been theorized that such designs have large stress components which conjugate at the sharp angles, as well as result in increased road noise and rolling resistance. Of course, engineers are constantly designing tread patterns to increase overall tire efficiency, but these design traits remain pervasive.

### SUMMARY OF THE INVENTION

In a first aspect of the invention, a tire comprises a lug pattern. Each lug of the lug pattern has a substantially oval shaped contacting surface and a plurality of variable angle sidewalls extending from a base to the substantially oval shaped contacting surface.

In another aspect of the invention, the tire comprises a plurality of same shaped lugs. Each of the plurality of same shaped lugs is offset with respect to one another in adjacent rows and includes a substantially rectangular base with convex sides and a substantially oval shaped contacting surface. A plurality of sidewalls extends from the substantially rectangular base to the substantially oval shaped contacting surface.

In another aspect of the invention, the tire comprises a plurality of lugs, each comprising: a substantially rectangular base with convex sides; a substantially oval shaped contacting surface; and a plurality of tapered and variable angle sidewalls extending from the substantially rectangular base to the substantially oval shaped contacting surface. The transition between each of the tapered and variable angle sidewalls for each of the plurality of lugs is devoid of sharp edges. A groove bottom positioned between adjacent lugs of the plurality of lugs has a rounded portion.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view of a tread pattern in accordance with an embodiment of the invention;

FIG. 2 is an enlarged front view of the tread pattern of FIG. 2, in accordance with an embodiment of the invention;

FIG. 3 is a top view of a single lug in accordance with an embodiment of the invention;

FIG. 4 is a cross sectional view of the tread pattern along line 4-4 of FIG. 2, in accordance with an embodiment of the invention; and

FIG. 5 is a cross sectional view of the tread pattern along line 5-5 of FIG. 2, in accordance with an embodiment of the invention.

### DETAILED DESCRIPTION OF EMBODIMENTS OF THE INVENTION

The present invention is directed to a tire with a tread pattern having superior performance characteristics. In embodiments of the invention, the tread pattern includes a lug pattern, where each lug of the lug pattern has a generally rectangular base with convex sides and an oval shaped contacting surface. The lug further has variable angle or flank angle sidewalls extending from the oval shaped contacting surface to the generally rectangular base. In the design of the invention, the sidewalls are also tapered with respect to a vertical axis. In use, the tread pattern of the present invention exhibits superior stone trapping resistance, groove cracking resistance, pressure distribution, as well as increased wet traction and tread mileage properties. It has also been found that the tread pattern of the present invention contributes to a decrease in road noise and further has a low rolling resistance thereby increasing vehicle efficiently.

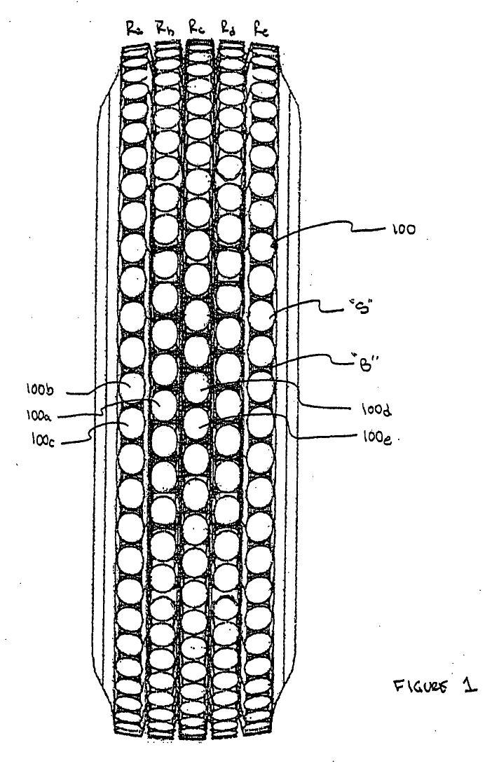

FIG. 1 is a perspective view of a tread pattern in accordance with an embodiment of the invention. In the embodiment of FIG. 1, the tread pattern includes a plurality of rows Rₐ, R_{b}, R_{c}, R_{d}, Rₑ of independent lugs, generally depicted as reference numeral 100. Although five rows of lugs are shown Rₐ, R_{b}, R_{c}, R_{d}, Rₑ, it should be understood that two or more rows of lugs 100 are further contemplated by the invention, depending on the specific application.

The lugs 100 each include a contacting surface “S” which is substantially oval in shape and, in one embodiment, has a length to width ratio with may be in the range of approximately 1.28:1 to 1.4:1, and more preferably approximately 1.3:1. It should be understood, though, that other length to width ratios are also contemplated by the invention, depending on such variables as tread width and tire outer diameter.

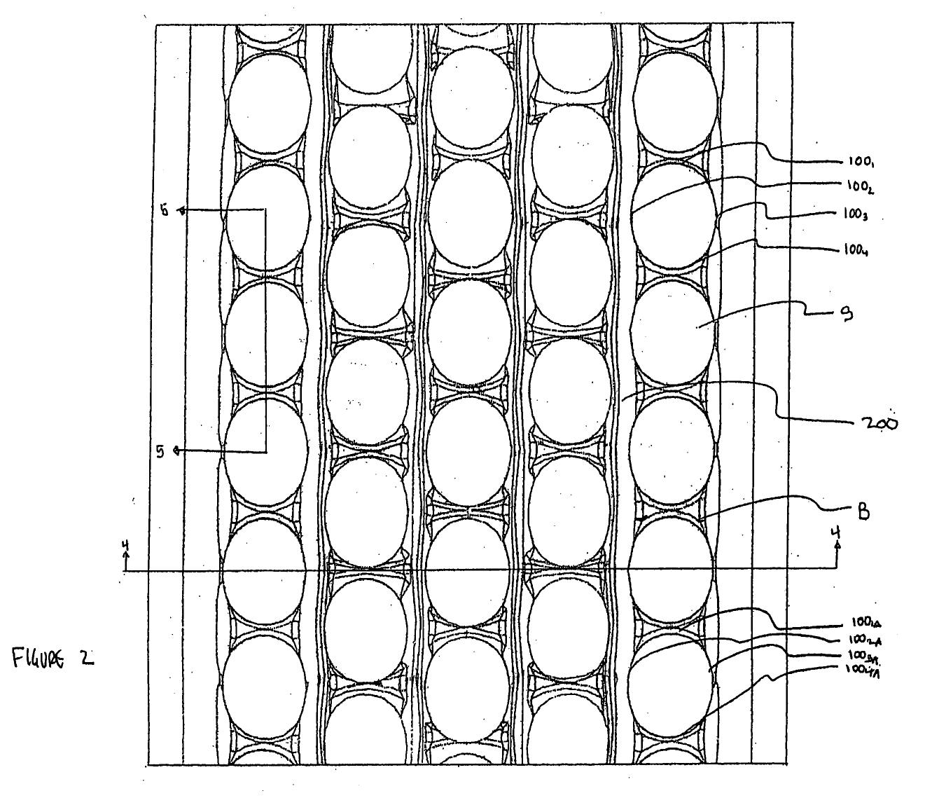

In the non-limiting embodiment of FIG. 1, each lug 100 is of the substantially same configuration and is offset or staggered with respect to a lug(s) in a neighboring row or rows. For example, lug 100a of row R_{b} is offset or staggered with respect to lugs 100b and 100c of row Rₐ and lugs 100d and 100e of row R_{c}. In this example, it is preferred that the lugs 100 are offset by about one-half its length with respect to the neighboring lugs; although other positions are also contemplated by the invention. Additionally, each lug 100 includes a substantially rectangular base “B” having convex sides. (See, FIG. 2.)

FIG. 2 is an enlarged view of the tread pattern shown in FIG. 1. As shown in FIG. 2, each of the lugs 100 has a generally rectangular base “B” with the plurality of slightly convex shaped sides 100₁, 100₂, 100₃ and 100₄. Variable angle sidewalls 100_{1A}, 100_{2A}, 100_{3A} and 100_{4A} extend from the convex shaped sides to the contacting surface of the lug 100.

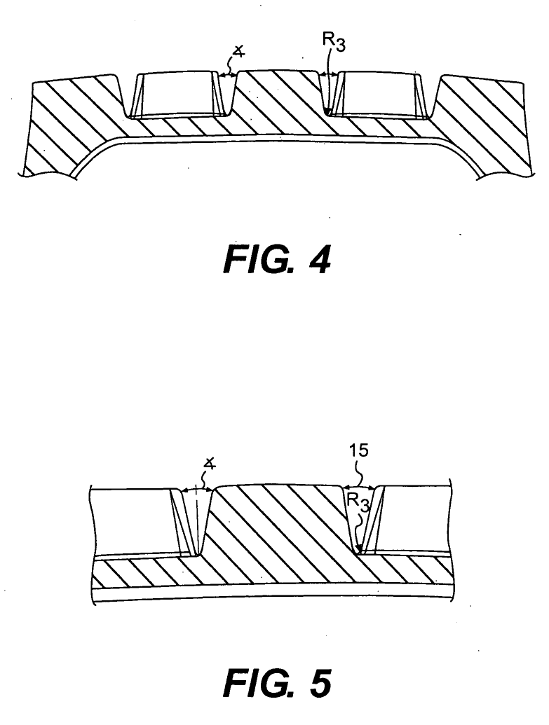

In addition, each of the variable angle sidewalls 100_{1A}, 100_{2A}, 100_{3A} and 100_{4A} is at an angle with respect to a vertical axis thus creating a tapered or pyramid-like appearance. A bottom 200 of the groove between each base “B” is rounded with a radius that may vary with respect to a location on the sidewall 100_{1A}, 100_{2A}, 100_{3A} and 100_{4A} of neighboring lug(s) in the same or different row, as discussed with reference to FIGS. 4 and 5. The rounded bottom portion 200 reduces stress concentrations at the bottom of the groove.

In further embodiments, the transition area “T” or corners between each of the sidewalls 100_{1A}, 100_{2A}, 100_{3A} and 100_{4A} as well as the contacting surface “S” of the lug and the sidewalls is rounded, eliminating any sharp edges.

The sidewalls 100_{1A}, 100_{2B}, 100_{3C} and 100_{4D} provide a variable groove angle and/or variable wall contour during rolling of the tire, thus reducing stone or other debris trapping. That is, using the tread design of the present invention, an angle is constantly changing on the side of the groove during roll of the footprint (e.g., rotating and flanking angles) thus contributing significantly to the release stones and/or other debris. Additionally, the varying wall contour and rounded edges improves the pressure distribution of the tire (due to the elimination of any sharp angles) which, in turn, results in:

(i) superior tread wear properties;

(ii) superior wet traction;

(iii) reduced noise; and

(iv) longer tread mileage.

It has also been found that the varying wall contour and/or rounded edges of the present invention reduces stress points in the tire due to the fact that forces cannot conjugate in one area, e.g., at any point or corner. Instead, by using the tread pattern of the present invention, the varying wall contour and rounded corners allows forces to travel upwards on the lug 100, thus eliminating places for forces to collect. This leads to improved groove cracking resistance. As one of ordinary skill in the art would recognize, the substantial reduction or elimination of stresses is due mainly to the elimination of any sharp edges or angles in the tire pattern design.

Still referring to FIG. 2, in one illustrative example, the tread depth is in the range 18 mm to 30 mm and the tread width is in the range of 8 mm to 20 mm. A bottom groove radius R₃ is approximately 2 mm, but may range between approximately 1 mm and 3 mm. The groove width between lugs 100 is approximately in the range of 3 mm to 12 mm, depending on such variables as, for example, the depth of the groove. It should be understood by those of skill in the art that the above examples are but one non-limiting illustration of the dimensions contemplated by the present invention, and that the above dimensions can vary in accordance with other design specifications.

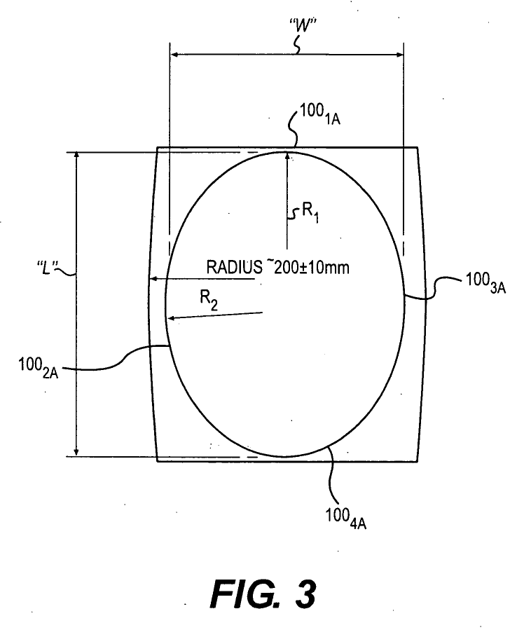

FIG. 3 is an enlarged view of a single lug 100 in accordance with an embodiment of the invention. As shown in this illustrative representation, the base of each lug 100 is formed in a generally rectangular shape, generally denoted as reference numeral 300, with slight convexity to each of the sides. The length “L” to width “W” ratio can range from about 1:1 to 1:1.125, and preferably about 1.16:1. The radius R₁ for the curvature along the length “L” (e.g., along the circumferential direction) is approximately in the range of 17 mm to about 18 mm, and preferably 17.4 mm, in the embodiment shown herein; whereas, the radius R₂ for the curvature along the width is larger than radius R₁ and is approximately in the range of about 37 mm to about 38 mm and preferably 37.2 mm, in the embodiment shown herein. Additionally, each side 100₁, 100₂, 100₃ and 100₄ is slightly convex and, in one embodiment described herein, has a radius, along the length, of about 200 mm+/−10 mm.

Additionally, each sidewall 100_{1A}, 100_{2B}, 100_{3C} and 100_{4D} is tapered and has a variable angle. By having the tapered sidewall, the volume and hence surface area of the of the lug 100 will increase from the contact surface to the base “B”. The radius R₁ and R₂ also increases gradually and continuously from the contact surface to the base “B”.

FIG. 4 is a cross sectional view of the tread pattern along line 4-4 of FIG. 2. As clearly shown, each of the sidewalls along the length “L”, is at a varying angle. As should be understood, since each of the sidewalls has a variable angle or contour, this angle will continually change with respect to the location to location measurement between the lugs. Thus, for example, the angle between sidewalls can be larger or smaller, depending on the location of measurement. Thus, a range of angles contemplated by the present invention is about 20 to 50, depending on the location of measurement. As further shown in FIG. 4, each side is slightly convex in shape.

FIG. 5 is a cross sectional view of the tread pattern along line 5-5 of FIG. 2. As shown clearly in this view, each of the sidewalls along the width “W” is at an angle. As should be understood, again, since each of the sidewalls has a variable angle or contour, this angle will continually change with respect to the location to location measurement. Thus, for example, the angle of each sidewall will be larger or smaller, depending on the location to location measurement. Thus, a range of angles contemplated by the present invention is about 20 to 50, depending on a location of measurement.

From a manufacturing standpoint, the material to produce the tread patterns should flow better into the mold since there are no sharp corners. Thus, the material does not have to squeeze into corners, but instead flows smoothly around rounded corners. This results in better material (e.g., rubber) flow in the mold during manufacturing, thus resulting in fewer defects.

The foregoing examples have been provided for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. The present invention is not r intended to be limited to the particulars disclosed herein; rather, the present invention extends to all functionally equivalent structures, methods and uses, such as are within the scope of the appended claims.

What is claimed is:

1. A tire comprising a lug pattern, each lug of the lug pattern having a substantially oval shaped contacting surface and a plurality of variable angle sidewalls extending from a base to the substantially oval shaped contacting surface.

2. The tire as claimed in claim 1, wherein each of the variable angle sidewalls is tapered.

3. The tire as claimed in claim 1, further comprising rounded edges at a transition between each of the variable angle sidewalls.

4. The tire as claimed in claim 1, wherein a footprint of the tire includes only the lug pattern, and each substantially oval shaped contacting surface has a same shape.

5. The tire as claimed in claim 1, wherein a length to width ratio of each substantially oval shaped contacting surface is approximately in the range from 1.28:1 to 1.4:1.

6. The tire as claimed in claim 1, wherein each lug of the lug pattern is offset with respect to a neighboring lug in an adjacent row.

7. The tire as claimed in claim 6, wherein the offset is approximately one-half a length of the lug.

8. The tire as claimed in claim 1, wherein the base is generally rectangular with convex sides.

9. The tire as claimed in claim 8, further comprising a groove bottom positioned between adjacent lugs of the lug pattern, the groove bottom being rounded.

10. The tire as claimed in claim 9, wherein the groove bottom has a radius of approximately 1 mm to 3 mm.

11. A tire comprising a plurality of same shaped lugs, each of the plurality of same shaped lugs are offset with respect to one another in adjacent rows and includes a substantially rectangular base with convex sides and a substantially oval shaped contacting surface, a plurality of sidewalls extend from the substantially rectangular base to the substantially oval shaped contacting surface.

12. The tire as claimed in claim 11, wherein the sidewalls are of a variable angle.

13. The tire as claimed in claim 12, further comprising a rounded groove bottom between adjacent lugs and rounded edges between each of the sidewalls of each of the same shaped lugs.

14. The tire as claimed in claim 11, wherein each of the sidewalls are tapered.

15. The tire as claimed in claim 11, wherein a length to width ratio of each of the same shaped lugs is approximately from 1.28:1 to 1.4:1.

16. The tire as claimed in claim 11, wherein the same shaped lugs increases in volume of material from the substantially oval shaped contacting surface to the substantially rectangular base.

17. The tire as claimed in claim 11, wherein a shape and angle of each of the sidewalls provides a variable groove angle and variable wall contour during rolling of the tire which reduces stress points in the tire and contributes to stone trapping resistance.

18. A tire comprising:
a plurality of lugs, each of the lugs of the plurality of lugs comprising:
a substantially rectangular base with convex sides;
a substantially oval shaped contacting surface; and
a plurality of tapered and variable angle sidewalls extending from the substantially rectangular base to the substantially oval shaped contacting surface,
wherein a transition between each of the tapered and variable angle sidewalls for each of the plurality of lugs is devoid of sharp edges, and
a groove bottom positioned between adjacent lugs of the plurality of lugs having a rounded portion.

19. The tire as claimed in claim 18, wherein each lug of plurality of lugs is offset with respect to a neighboring lug in an adjacent row by approximately one-half its length.

20. The tire as claimed in claim 18, wherein a shape and angle of each of the tapered and variable angle sidewalls provides a variable groove angle and variable wall contour during rolling of the tire which reduces stress points in the tire and contributes to stone trapping resistance.
